(19) United States
(12) Patent Application Publication
(10) Pub. No.: US 2024/0196344 A1
(43) Pub. Date: Jun. 13, 2024

(54) SPECIFIC ABSORPTION RATE MANAGEMENT AND SELECTION OF LINK RATE CONSIDERING SPECIFIC ABSORPTION RATE PARAMETERS

(71) Applicant: Intel Corporation, Santa Clara, CA (US)

(72) Inventors: Vamshi Krishna AAGIRU, Bangalore (IN); Nithesha ANANDA, Surathkal (IN); Santhosh AP, Bangalore (IN); Abir CHATTERJEE, Khandaghosh (IN); Sajal Kumar DAS, Bangalore (IN); Walid EL HAJJ, Antibes (FR); Noam KOGOS, Ramat Hasharon (IL); Adiel LANGER, Petah Tiqwa (IL); Gil MEYUHAS, Tel-Aviv (IL); Amir RUBIN, Kiryat Ono (IL); Michael SHACHAR, Kfar Glikson (IL); Nidhi P. SHETTY, Bangalore (IN); Madhukiran SRINIVASAREDDY, Bangalore (IN); Ricardo VELASCO, San Jose, CA (US)

(21) Appl. No.: 18/063,094

(22) Filed: Dec. 8, 2022

(51) Int. Cl. H04W 52/36; H04W 52/22; H04W 76/28

(52) U.S. Cl. CPC H04W 52/367; H04W 52/225; H04W 76/28

(57) ABSTRACT

Devices with radiating antennas are subject to various regulations designed to limit the absorption of radiofrequency energy in a human body part in close proximity to a radiating antenna. Various conventional strategies are available for management of transmissions to comply with these regulations; however, each of these conventional strategies has drawbacks, such as a negative effect on the wireless link. Various strategies are disclosed herein to comply with the requisite regulations while maintaining the wireless link. In addition, strategies are presented to select wireless link rates, taking into account limitations that may be in place to satisfy the necessary regulations.

### TECHNICAL FIELD

Various aspects of this disclosure generally relate to techniques for the management of transmission power and transmission antenna selection to comply with specific absorption rate regulations and the selection of a wireless link rate in light of specific absorption rate parameters.

### BACKGROUND

All mobile devices with radiators are subject to specific absorption rate (SAR) regulations, which are imposed by a variety of jurisdictions across the globe. Although many techniques and algorithms have been developed to satisfy SAR regulations, most or all rely, at least in part, on lowering transmit power. Very often, the transmit power is lowered to a level far less than the maximum power permitted by The Mobile Broadband Standard Partnership Project (3GPP), which may be, for example, 21 dBm with a 2 dBm tolerance. In a typical call under poor coverage conditions, channel loss with such a power back off will be significant, and greater transmit power is needed to maintain link reliability and quality. Otherwise stated, reducing the transmit power often results in poor link reliability and performance. According to a first aspect of the disclosure, it is desired to manage wireless transmissions to comply with SAR regulations without reducing transmit power.

According to a second aspect of the disclosure, compliance with SAR regulations conventionally requires reduction of transmit power, which may lead to link instability and poor user experience. Although some data traffic is crucial for maintenance of the wireless link, other data traffic is less crucial and would be unlikely to affect the wireless link if not received or decoded directly.

When a wireless transmitter determines optimal transmit rates during a link-quality (LQ) assessment, it does not take into consideration other system's limitations (e.g., limitations of a SAR management circuit), such as SAR events and transmit power per antenna, or other system limitations per antenna that can derive from platform interference or other regulatory limitations. The failure to consider these limitations results in the LQ algorithms selecting unoptimized data rates, or results in high convergence latencies, such as single input single output (SISO)/multiple input multiple output (MIMO) decisions and SISO antenna selection, and it ignores energy balance issues in a SISO that can cause power backoffs or time backoffs while another transmit chain would have a sufficient energy credit to transmit without any backoffs.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary embodiments of the disclosure are described with reference to the following drawings, in which:

FIG. 1 depicts a computing device according to the first aspect of the disclosure;

FIG. 2 depicts a time averaged transmit power of an antenna during an antenna hopping procedure;

FIG. 3 depicts a flowchart of the antenna hopping technique;

FIG. 4 depicts a computing device for antenna hopping according to the first aspect of the disclosure;

FIG. 5 depicts an implementation of the power backoff solution of the second aspect of the disclosure;

FIG. 6 depicts a mapping of logical channels, transport channels, and physical channels in cellular communication;

FIG. 7 depicts the dynamic power adjustment method according to the second aspect of the disclosure;

FIG. 8 depicts an effect of the selective power reduction techniques compared to transmission at regular power;

FIG. 9 depicts a computing device;

FIG. 10 depicts a flowchart of the chain grading power control procedure disclosed herein;

FIG. 11 depicts a flowchart for TPC power reduction; and

FIG. 12 depicts a computing device.

### DESCRIPTION

The following detailed description refers to the accompanying drawings that show, by way of illustration, exemplary details and embodiments in which aspects of the present disclosure may be practiced.

The word “exemplary” is used herein to mean “serving as an example, instance, or illustration”. Any embodiment or design described herein as “exemplary” is not necessarily to be construed as preferred or advantageous over other embodiments or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint™, among others, or any combination thereof. Registers, shift registers, processor registers, data buffers, among others, are also embraced herein by the term memory. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

According to a first aspect of the disclosure, a time averaging (TA)-SAR procedure uses an antenna hopping technique to preclude a SAR-affected antenna from exceeding an upper power threshold. During operation of the computing device, a human body part may fully or partially obstruct one or more of antennas, which will be referred to throughout herein as a SAR event. During a SAR event, the affected one or more antennas are subject to a SAR regulation, which may be a legal limit imposed upon the cumulative transmit power of an affected antenna over time. Various jurisdictions impose regulations for SAR compliance.

In current cellular modem implementations, a wireless transmission typically takes places through a dedicated antenna, and therefore the antenna must always comply with the relevant human exposure regulatory limit. To meet this regulatory requirement, the device manufacturers normally employ a proximity sensor to detect the human presence or use TA-SAR mechanism. In Time averaging SAR method, the overall TX power is reduced by a certain amount irrespective of the proximity detection based on the pre-defined duty cycle, which affects the system performance and link reliability in the poor coverage area.

In TA-SAR, a specific absorption rate is calculated for human tissue in close proximity to an antenna over a period of time. This is done with a moving time window, during which the total energy absorbed by the human tissue must fall beneath the regulatory limit. Various strategies exist to reduce transmit power, so as to comply with the relevant SAR regulations during a SAR event. Reduced power, however, may have a negative effect on a wireless link and therefore it is desired to develop alternative strategies to maintain a wireless link without a power back off.

A computing device may perform the procedure described herein using one or more existing modems, provided that the modem is configured to transmit on multiple antennas (e.g., a 2×2 antenna configuration, a 4×4 antenna configuration, etc.). The modem makes use of a switching mechanism (e.g. a multiplexer) to selectively connect the modem to individual antennas for this antenna hopping technique.

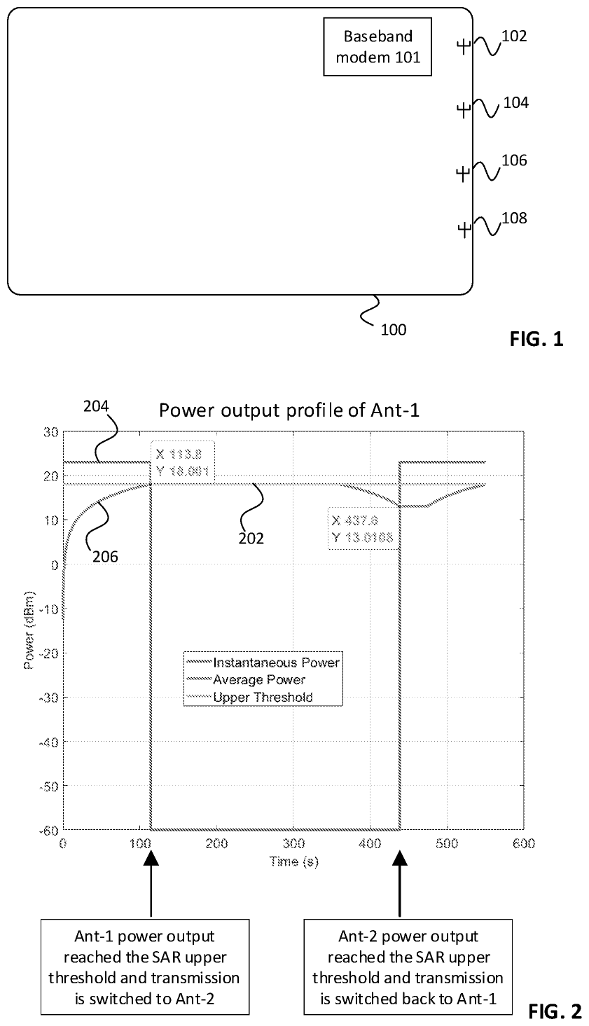

FIG. 1 depicts a computing device 100 according to the first aspect of the disclosure. This computing device 100 includes at least one baseband modem 101, which is configured to receive data to be transmitted and to convert these data into a modulated radiofrequency signal for transmission. The baseband modem may be configured to transmit on a plurality of antennas. In some configurations, the baseband modem 101 may be configured to transmit simultaneously on two or more antennas (e.g. a MIMO transmission). Alternatively or additionally, the baseband modem 101 may be configured to transmit on any of a plurality of antennas. The baseband modem may be connected to the plurality of antennas via one or more multiplexers (not shown), which may be configured to selectively connect the baseband modem to any of the one or more antennas. FIG. 1 depicts an exemplary configuration of a baseband modem 100 and one that is configured to transmit on any of four antennas, which are labeled as 102, 104, 106, and 108.

If a transmission takes places on a single antenna continuously, the SAR value quickly reaches the maximum transmit energy permitted by the relevant SAR regulation (e.g. the statutory or regulatory limit for the given jurisdiction). For example, an antenna transmitting with an output power of 23 dBm will reach a SAR value of 5.81 W/kg after ˜100 seconds. By reducing the antenna transmission duty cycle to 50%, however, (e.g. by hopping the transmission between two antennas), the SAR value reaches only 3.04 W/kg. Similarly, if the antenna transmission duty cycle is reduced to only 25% (e.g., by hopping the transmission among four antennas), the SAR value can be further reduced.

The procedure for TA-SAR compliance as described herein will be referred to as antenna hopping. During an antenna hopping procedure, the average transmit power of the affect antenna (e.g., the antenna subject to a SAR condition) is continuously monitored and compared against the pre-defined SAR upper threshold. When the average transmit power exceeds the SAR upper threshold, the transmission is switched from the current antenna to a second antenna. The average transmit power of the second antenna is then continuously monitored and compared against the pre-defined SAR upper threshold.

When the average transmit power of the second antenna exceeds the SAR upper threshold, the transmission is switched from the second antenna. In a first configuration, the transmission may be switched back to the first antenna. In a second optional configuration, the transmission may be switched to a third antenna. Each, or fewer than each, of the available antennas may be utilized in the antenna hopping procedure.

FIG. 2 depicts a time averaged transmit power of an antenna during an antenna hopping procedure, according to the first aspect of the disclosure. In this figure, the time average SAR regulation is depicted as 202. The transmit power on the antenna is depicted as 204. The time averaged transmit power is depicted as 206. In an optional, exemplary configuration, the following values are used for demonstrative purposes:
P=Max_Power_DPR_OFF=23 dBm
U=Avg_SAR_UppThresh=18 dBm
Tr=Avg_SAR_Check_Period=0.1 s
Tc=Avg_SAR_Roll_Period=360 s

In this figure, a transmission is instituted at time zero with transmission power of approximately 23 dBm. The time averaged power 206 on this antenna rises until it reaches the regulatory SAR threshold 202 of at dBm after 113.8 seconds. Upon reaching the threshold, the transmission is discontinued (designated by a drop to −60 dBm at 113.8 seconds). During this period in which the antenna is not used for transmission (from 113.8 seconds to 437.8 seconds in this figure), the average transmission power begins to drop, thereby generating sufficient buffer in the power budget for the antenna to be subsequently used. At approximately 437.8 seconds, the average transition power has dropped from the regulatory maximum 202 to 13.0108 dBm. At 437.8 seconds, the transmission is shifted back to the antenna, and the average transmission power again begins to rise.

Advantageously, this procedure improves wireless communication performance, because the overall power thresholds remain unreduced (or at least are not reduced as much as in conventional methods). As a result, the overall time that a signal is transmitted at maximum transmit power is also increased. This leads to improved stability of the wireless link and increased throughput.

In carrying out this procedure, the computing device may be configured to use an arithmetic mean to calculate the average power of a transmit antenna during a given averaging time Ta. The mean may be calculated each Tr period defining the resolution or the granularity of the hopping period. In an optional configuration, the baseband modem may be configured to transmit on each antenna, one at a time, at a maximum allowable transmission power.

The maximum power level in a Dynamic Power Reduction (DPR) state is noted as DPR_ON and in the non-DPR state is noted DPR_OFF. The basic arithmetic averaging may be calculated as

$$A v g = \frac{1}{{T}_{a}} {\sum }_{i = 1}^{N} {Power}_{i} .$$

When the average power reaches the TA-SAR upper threshold (Avg_SAR_UppThresh), the antenna switching is activated, the Dynamic Power Reduction (DPR) state is turned ON, and the transmission over the current antenna is switched to the next TX antenna. In the same way when the average power of the next antenna reaches the TA-SAR upper threshold (Avg_SAR_UppThresh), the Dynamic Power Reduction (DPR) state may be turned ON, and the transmission over the current antenna may be switched back to the previous antenna or to a different TX antenna based on the modem UL TX antenna configuration.

As stated above, this procedure may be utilized in lieu of reliance on proximity sensors to detect the presence of a human body part in close proximity to the underlying antenna. That is, in a first configuration the computing device may be configured to implement the TA-SAR procedure disclosed herein in the absence of proximity sensors. Even when no proximity sensors are present, the TA-SAR procedure ensures that appropriate SAR regulations are complied with.

Proximity sensors have a nonzero false positive rate, which means that the proximity sensors occasionally, erroneously detect human body parts in close proximity to an antenna. Where a proximity sensor detects a human body part (even when the proximity sensor falsely detects a human body part), a SAR compliance schema will be implemented. By utilizing the TA-SAR scenario as disclosed herein, the need for proximity sensors may be obviated and therefore reduction of transmit power due to a false positive becomes a nonissue.

Alternatively, the computing device may optionally use one or more proximity sensors in addition to the TA-SAR procedure disclosed herein. In this configuration, the antenna hopping procedure of the first aspect of the disclosure may be employed whenever, or only when, a proximity detector detects a human body part within close proximity to a transmitting antenna. Although this requires the presence of proximity sensors, unlike in the first configuration, a computing device may be configured to implement the antenna hopping procedure only when a human body part is detected in close proximity to an antenna, thereby allowing MIMO or other transmission protocols/configurations to be implemented when no human body part is detected.

Furthermore, the use of antenna hopping as described herein solves the overshoot problem associated with conventional time averaging algorithms. In these time averaging algorithms, a power back off is instituted when the time averaged power reaches a predetermined threshold. However, even once the power backoff is instituted, the average power will continue to briefly rise, which may result in overshooting the regulatory SAR limit. Because the signal in the antenna hopping method as disclosed herein is switched from antenna to antenna, the time averaged signal does not continue to rise after a power backoff is initiated, thereby solving the overshoot problem.

In a simulation of the TA-SAR technique described herein, continuous transmission over one antenna with a maximum power of 23 dBm was modeled over 100 seconds. In this simulation, the TA-SAR value was 5.81 W/kg, which is significantly over the applicable regulatory SAR limit of 1.6 W/kg used for this analysis.

To meet the SAR regulatory limits, the transmit power needs to be reduced to 16 dBm, which would represent a total reduction of 7 dB from the maximum power of 23 dBm. This 7 dB reduction in power will adversely affect reliability.

When two-antenna hopping is enabled, however, and therefore the transmission is split over two antennas with a 50% duty cycle, the SAR value becomes 3.04 W/kg, which indicates that the SAR value is reduced by 50% with two-antenna switching. Although the two-antenna hopping did not technically comply with the applicable SAR regulation, it indicates that significant reductions in TA-SAR may be achieved with the antenna hopping technique.

To further test this idea, an additional simulation was attempted with a transmission power of 23 dBm, split over 4 antennas. When the four-antenna hopping is enabled and the transmission is split over four antenna with a 25% duty cycle, the SAR value is 1.57 W/kg and thus satisfies the SAR regulatory requirement. This demonstrates that the SAR value is reduced by ˜75% with four-antenna switching.

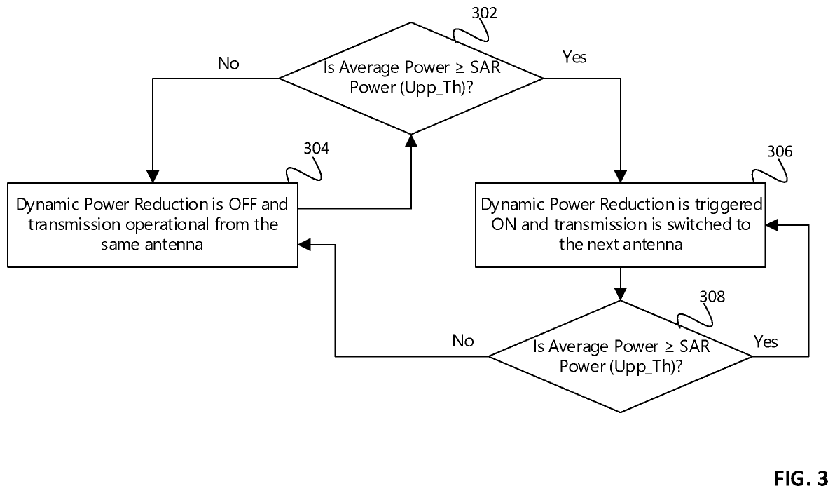

FIG. 3 depicts a flowchart of the antenna hopping technique according to the first aspect of the disclosure. In this figure, a processor of the computing device determines whether the time averaged power is greater than or equal to the SAR power upper threshold 302. If the time average power is less than the SAR power threshold, then the dynamic power reduction according to the first aspect of the disclosure may be turned off, and the transmission may continue to be operational from the same antenna 304. That is, the computing device (e.g. a baseband modem of the computing device) may continue to transmit on the same antenna until the threshold is reached. Once the SAR power threshold is reached, then the dynamic power reduction schema (e.g. antenna hopping) is triggered, and the transmission is switched to another antenna 306. Thereafter, it is assessed whether the time averaged power on the another antenna is greater than or equal to the SAR power upper threshold 308. If the time averaged power on the another antenna is less than the SAR power upper threshold, then the dynamic power reduction is turned off (e.g. no antenna hopping is performed at this time), and the transmission is allowed to continue on the another antenna. If the time averaged power on the another antenna is greater than or equal to the SAR power threshold 308, then the dynamic power reduction is triggered on and the transmission to switch to yet another antenna (or return to the first antenna) 306.

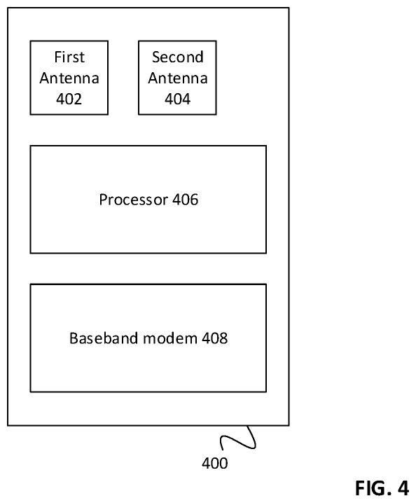

FIG. 4 depicts a computing device for antenna hopping according to the first aspect of the disclosure. The computing device may include a first antenna 402, a second antenna 404, and a processor 406. The processor 406 may be configured to perform an antenna hopping operation, wherein the antenna hopping operation may include calculating a first transmit power value representing a transmit power on the first antenna during a transmit period; and when the first transmit power value reaches a threshold, controlling a baseband modem 408 to begin a second transmit period on the second antenna. The antenna hopping operation may optionally further include that when the first transmit power value reaches the threshold, the processor 406 controls the baseband modem 408 to discontinue transmission on the first antenna during the second transmit period. Alternatively or additionally, the antenna hopping operation may further include the processor calculating a second transmit power value representing a transmit power on the second antenna during the second transmit period; and when the second average transmit power reaches a threshold, beginning a third transmit period on the first antenna or a third antenna. The hopping operation may further include, when the second transmit power value reaches the threshold, controlling the baseband modem to discontinue transmission on the second antenna during the third transmit period.

In a second aspect of the disclosure, transmit power adjustment (e.g. transmit power backoff) may be performed depending on whether the underlying data are critical or non-critical. In particular, the transmit power adjustment may be performed for different physical channels based on whether the physical channel is carrying critical or non-critical information in a SAR limited scenario.

As described herein, a user detection module (e.g. a processor or controller receiving proximity sensor data) detects a human body part within close proximity to an antenna and institutes a SAR management procedure (e.g. a power backoff). That is, in contrast to that of the first aspect of the disclosure, the principles and methods of the second aspect of the disclosure are likely to include usage of one or more proximity sensors, although the power backoff described herein could be widely implemented without the use of proximity sensors to ensure SAR compliance. Once the proximity of a human body part is detected, the computing device estimates an amount of transmit power reduction needed for channels carrying critical (value of X) or non-critical (value of Y) information in different SAR limited scenarios.

The SAR controller utilizes these power backoff values to implement differing power backoffs depending on the data to be transmitted. In this manner, the SAR controller (or optionally any other controller or processor in the computing device) detects the information type carried in different physical channels (e.g., Physical Uplink Control Channel (PUCCH), Physical Uplink Shared Channel (PUSCH)) and categorizes whether the data are critical (e.g. a failure to receive or decode this message in a base station receiver could lead to radio link failure, call drop, handover failure, etc.) or non-critical (e.g., decoding failure of this message will not lead to radio link failure, call drop, handover failure etc.).

Based on that categorization (e.g., critical or non-critical), the Transmit power for that channel's transmission is reduced (backed-off) to the maximum transmit power minus X (P_Tx−X) dB or the maximum transmit power minus Y (P_Tx−Y) dB. Where X>Y. That is, a X dB reduction is applied to non-critical transmissions, and a Y dB reduction is applied to critical transmissions. The value of Y could be 0 dB, meaning that in some instances, there may be no reduction of transmit power for critical data.

Moreover, in some cases, and based on the channel type and carrying information (e.g. user data), some blocks' or frames' transmissions may be skipped (e.g., alternate blocks are transmitted in SAR scenarios) to keep the average transmit power below the SAR average transmit power threshold.

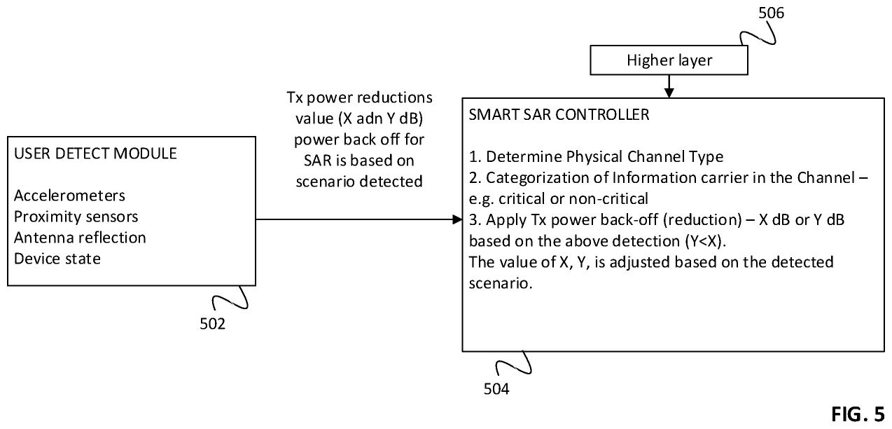

FIG. 5 depicts an implementation of the power backoff solution of the second aspect of the disclosure. In this figure, transmit power is adjusted in a SAR-limited scenario (e.g., the computing device implements an X dB reduction for non-critical data and a Y dB reduction for critical data). Using the principles and methods disclosed herein with respect to the second aspect of the disclosure, a SAR control module may monitor user scenarios that are active on the connected device, as well as critical signaling messages between the UE and network, and it may accordingly toggle a reduction in transmit power to ensure continuity in link, while ensuring that SAR backoffs are only used when needed. Should a human body part be detected in close proximity to the device, the SAR controller 504 may perform various steps to reduce the transmit power according to the principles and methods disclosed herein. In this manner, the SAR controller 504 may determine a Physical Channel Type; categorize the information in the channel as being either critical or non-critical; and apply a transmit power backoff as disclosed herein using X and Y, wherein the value of X and Y is determined based on the detected scenario.

The computing device may include a user detection module 502, which may be configured to use available sensors and or elements on the computing device. These sensors may include proximity sensors, accelerometers, or other sensors configured to detect a human body part in close proximity to an antenna, such as baseband modems configured to detect a nearby human body part form reflected radiofrequency energy, etc. Using these sensors, the computing device detects the use case scenario as described below and provides the SAR Controller Module with the estimated power reduction values (X or Y values) based on the current scenario. The X and Y values are subtracted from the transmit power value (e.g. a maximum permissible transmit power) for estimating the transmission power for that message transmission. X is generally a higher value and applied to some channels when they are carrying non-critical information, and Y is lower in value and applied to some channels when carrying critical information.

In an optional configuration, the value of Y could be as low as 0 dB (e.g., no transmit power reduction for that transmission) so that no change in transmit power occurs when that channel information is very critical for the network. Alternatively or additionally, and conversely to the value of Y, the value of X may be selected to be any value, provided that X>Y and X<=the maximum transmit power. As can be seen from these criteria, in some circumstances, the transmit power backoff for noncritical data (e.g., X) may be equal to the maximum transmit power, such that the resulting transmit power is zero and no transmission occurs.

In a further optional configuration, the value of X and Y could be adjusted based on user proximity. For example, if any accelerometers are used, the accelerometer may be configured to detect whether a computing device is resting on a user's lap, or resting on a table or other stable surface (accelerometers are sufficiently sensitive to detect even small movements that occur as a result of resting on a user's lap). In contrast, if the computing device is on a table, these small movements will generally be absent, thereby suggesting that the device is not resting on a user's lap. In this scenario (e.g. when the device does not appear to be resting on a user's lap). The transmit power backoff may be reduced to a lower limit value.

Alternatively or additionally, and according to an additional configuration of the second aspect of the disclosure, the proximity sensors may be used to estimate a distance between a detected human body part and a nearby antenna (or the sensor itself) and apply a custom transmit power backoff based on the detected distance. In this manner, the values of X and Y may be selected based on a distance between a detected human body part and a reference portion of the computing device such that a greater transmit power backoff is applied to situations in which the detected human body part is within a very close proximity to the computing device, and a reduced power backoff is applied to situations in which the detected human body part is more distant to the computing device.

In an additional optional configuration according to the second aspect of the disclosure, antennas can be used to detect reflected power of human artifacts and apply a transmit power backoff when detected; however, when reflected power is not present, the device may be configured to permit a greater transmit power (e.g. a less reduced transmit power by virtue of the power backoff, or a transmit power that has not been reduced by the power backoff). In an exemplary configuration, one or more aspects of the computing device may determine whether the computing device is connected to a dock or docking station. Such a connection to a dock or docking station may be understood as a proxy for a determination that a human is not within close proximity to a radiofrequency antenna. In this manner, detection that the device is docked may prompt the computing device to discontinue a power backoff or to select values for X and Y such that a power backoff is minimal or nonexistent. Similarly, other determinations may be selected as a proxy for a determination that a human body part is not within close proximity to the computing device. These may include, but are not limited to, whether a device's lid is open or closed, whether a device's screen is active or inactive, or otherwise.

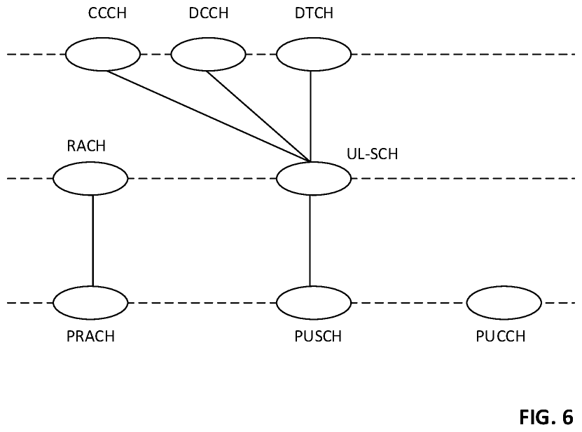

Once it is determined whether the device is in a SAR scenario (e.g. whether a transmit power backoff must be attempted), the computing device must determine how to implement the transmit power backoff to preserve the underlying wireless link. FIG. 6 depicts a mapping of logical channels, transport channels, and physical channels in cellular communication. That is the logical channels are mapped to a transport channel, and these are then mapped to a physical channel. Then, each physical channel is transmitted with the allocated transmit power, which is generally computed based on an open loop or closed loop power control method. If a user's body part is in close proximity to the transmit antenna, the transmit power is reduced due to the SAR limitation. Conventionally, however, the transmit power of all channels is blindly reduced by a certain amount (e.g. all transmit channels have the same power backoff). This severely impacts the system performance since, when channels carrying critical information are not decoded properly by the network entity (e.g., by the gNB or eNB) after several attempts (e.g., such as due to power backoff), the radio link may fail or the call may drop.

As depicted in FIG. 6, the two main physical channels in 5G/LTE systems are PUCCH (an uplink control channel) and PUSCH (an uplink shared data channel). These carry different types of information. The information could be critical (e.g., the information is very important, and a decoding failure of these messages could lead to radio link failure, call drop, or handover failure, etc.) or non-critical (e.g., the decoding failure may not lead to any such issue but may instead lead to re-transmission, call quality issues, etc.).

The computing device may easily detect the channel type, such as whether the channel is PUCCH or PUSCH. The PUCCH information is generally created in the physical layer, whereas PUSCH channel's data is either signaling data (protocol stack) or user application data. Similarly, the computing device can easily detect information carried in the PUCCH or PUSCH channel, and based on the detection, the computing device may mark (e.g. assign a status of) the data as being critical or non-critical.

In the case of PUCCH, PUCCH data may be designated by any of six formats as follows:

| PUCCH Format | Control Type |
|---|---|
| 1 | Scheduling request |
| 1a | 1-bit ACK/NACK |
| 1b | 2-bit ACK/NACK |
| 2 | CQI |
| 2a | CQI + 1-bit ACK/NACK |
| 2b | CQI + 2-bit ACK/NACK |

By knowing the format type of PUCCH as shown in this figure, the criticality can be determined. Specifically, PUCCH formats 1, 1a, 1b are critical, whereas PUCCH formats 2, 2a, and 2b are non-critical.

Turning to the PUSCH, the PUSCH is used to transfer (1) radio resource control (RRC) signaling messages, (2) Application/User data (3) and occasionally uplink control information (UCI). Of these, (1) and (3) are critical, whereas (2) non-critical. A computing device may easily determine whether PUSCH data is user data or a protocol signaling message, as these can be easily detected by knowing the header information in physical layer e.g. checking the L2 message header part.

For critical PUSCH data in the form of radio resource control (RRC) signaling messages or uplink control information—that is, in the case of types (1) or (3) from the table above—the computing device may implement a smaller reduction of transmit power (e.g. say, Y dB). In contrast, the in case of (2), the computing device may implement a larger reduction of computing power, such as by X dB (where X>Y). As an alternative to a transit power reductions for (2), the computing device may it skip the transmission altogether (e.g. a transmit power reduction equal to the transmit power, transmitting at a power of zero, etc.). This may be performed, for example, if the QoS requirement of the application is low and the user is in very close proximity to the Tx antenna etc.

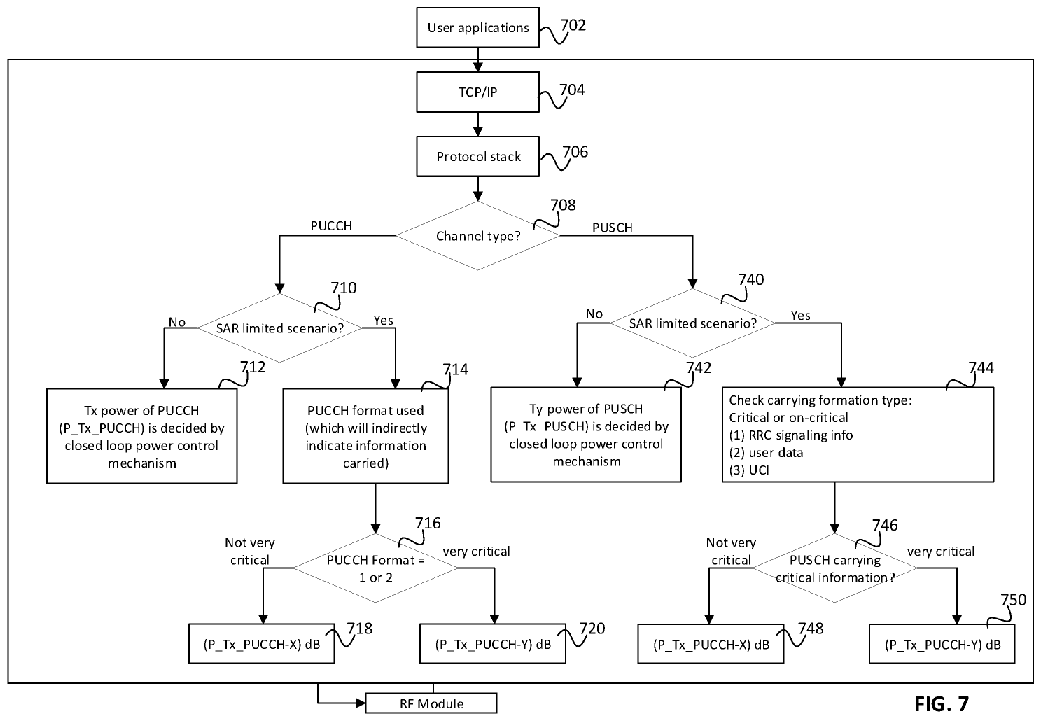

Once the channel type and carried information type (critical or non-critical) are identified as above, then the dynamic power adjustment method is applied to compute the actual transmit power to be used for that channel's that instant's information transmission. FIG. 7 depicts the dynamic power adjustment method according to the second aspect of the disclosure. In this method, the transmit power is adjusted for different physical channels based on whether it is carrying critical or non-critical information as described herein. Elements 702 (the user application layer), 704 (the internet protocol suite (TCP/IP)) and 706 (the protocol stack) contextualize the user data. Within the protocol stack, certain data to be transmitted may be PUCCH data, while other data to be transmitted may be PUSCH data.

The PUSCH physical channel carries Uplink Control Information (UCI) (e.g., channel state information (CSI), channel quality indicator (CQI), rank indicator, precoding matrix indicator (PMI), precoding type indicator (PTI), etc.), scheduling requests, and acknowledgement and non-acknowledgement (ACK/NACK).

In a non-SAR limited scenario, the PUCCH transmit power (P_Tx_PUCCH) may be decided by the closed loop power control mechanism described in the 3rd Generation Partnership Project (3GPP) standard TS 36.213 entitled “Evolved Universal Terrestrial Radio Access (E-UTRA)”. In a SAR limited scenario, however, the transmit power is reduced by X dB. Conventionally, transmit power for PUCCH (P_Tx_PUCCH) is reduced blindly to (P_Tx_PUCCH—power reduction factor) dB. This often results in degraded radio link conditions and thus unreliable communication.

As described herein, and in accordance with FIG. 7, the SAR Control will determine the channel type 708 to identify data to be transmitted as PUCCH or PUSCH data. If the data for transmission are identified as PUCCH data, then the SAR controller will determine whether the computing device (e.g. an antenna within the computing device) is in a SAR limited scenario 710. If no SAR limited scenario exists, then the transmit power for the PUCCH data is decided by the conventional closed loop power control mechanism 712. If, however, a SAR limited scenario exists 710, then the SAR controller determines the PUCCH format used 714. This PUCCH format is closely associated with the nature of the information to be transmitted and thus may be useable as a proxy for determining critical and non-critical data.

If the PUCCH format type is 1 (e.g., the data represent as scheduling request) or 2 (e.g. the data represent a CQI) 716 (e.g. not very critical data), then the SAR controller reduces the transmit power by X dB 718. Otherwise, for other format types, the SAR controller understands the data to be critical, and does not reduce the transmit power by X dB. Instead, the SAR controller either does not reduce the transmit power at all, or the SAR controller reduces the Tx power by a lower amount (e.g., by Y dB, wherein Y<X) 720; note that Y could be zero, meaning no power back off for the critical data.

In contrast to PUCCH, The Physical Uplink Shared Channel (PUSCH) is used to transfer RRC signaling messages, application/user data, and occasionally UCI. If the computing device detects PUSCH at 708, then the computing device determines whether the computing device (e.g. an antenna of the computing device) is in a SAR limited scenario 740. In a non-SAR limited scenario, the PUSCH transmit power (P_Tx_PUSCH) is decided by the closed loop power control mechanism 742. In a SAR limited scenario, however, the Tx power has to be reduced by X dB. Conventionally, the P_Tx_PUSCH is blindly reduced by a factor, which may degrade the radio link and thus render the wireless communication unreliable. As disclosed herein, however, the SAR controller will determine whether the PUSCH data correspond to RRC signaling information, user Data, or UCI 744.

If the PUSCH data are or include RRC signaling data or UCI data (e.g., if PUSCH data include critical information 746), then the SAR controller reduces the transmit power by Y dB, wherein Y<X. In this case, Y could be even 0 dB, meaning no power backoff for the critical data 750. Otherwise, for other types (e.g. for user data), the SAR controller reduces the transmit power by X dB 748.

It may occur, such as when a user's body part is in close proximity to an antenna, that X or Y cannot be smaller than the required backoff to ensure SAR compliance for the channel (e.g. the channel carrying critical/non-critical info). In that case, some block's/frame's transmissions may be skipped. That is, for PUSCH user data transmissions, the SAR controller may reduce the Tx power on a blockwise or framewise basis (e.g., for N block, the transmit power is reduced by X dB, and for N+1 block, the transmit power is not reduced). The value of X could be just as high as the Tx power, and in such cases, no transmission is made (as PTx−X=0 dB). Otherwise stated, the transmission may be skipped for those blocks. This may occur in scenarios such as when the QoS requirement of the running application is lower, then skipping blocks will not degrade quality, or when the user is in very close proximity to the Tx antenna then X should be as high as the transmit power (PTx), thereby resulting in no transmission).

This procedure helps to maintain the Time Average Tx power inside the SAR limit as shown in FIG. 6.1.f. With this the average Tx power goes below SAR limit.

In an optional configuration, and within the computing device, when the physical layer receives a control or data message (e.g. from the radio resource control (RRC) layer or the medium access control (MAC) layer, the physical layer checks the information that it is carrying to the network. Using the techniques described herein, the physical layer marks the message as being either critical or non-critical signaling, or non-critical user data. If transmitted message is marked as critical, and a human body part is detected within close proximity to an antenna, then the computing device (e.g. the SAR controller of the computing device) will not reduce the transmit power for these critical data. Otherwise, if the message is non-critical and/or carrying user data, then the computing device (e.g. the SAR controller of the computing device) may reduce the power (e.g. to a minimum power) or even skip transmission (e.g. transmit at zero power). Otherwise, if the data are non-critical and carrying signaling data, then the computing device (e.g. the SAR controller of the computing device) may reduce power by a power reduction factor, which may be a predetermined amount. Using these techniques, the TA-SAR may be kept beneath the regulatory limit while avoiding radio link failure.

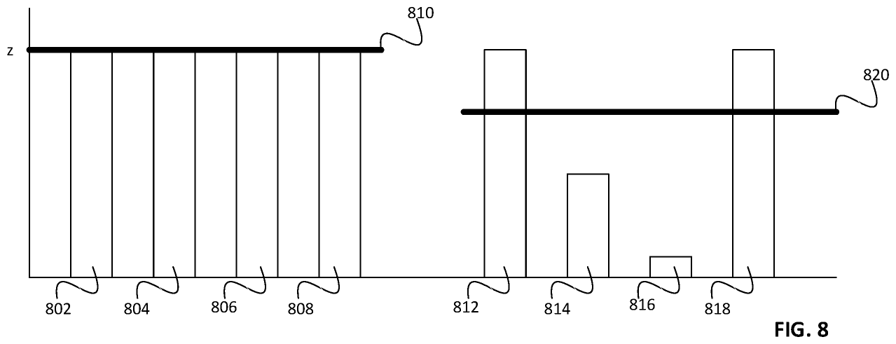

FIG. 8 depicts an effect of the selective power reduction techniques disclosed herein on the TA-SAR compared to transmission at regular power. In FIG. 8, four data transmissions at full transmit power (z dBm) are shown as 802, 804, 806, and 808. The average transmit power is depicted by black line 810. Since each transmission is transmitted at z dBm, the average transmit power is z dBm 810.

The second half of FIG. 8 depicts transmissions that use the power backoff strategies disclosed herein. In this portion of the figure, four data transmissions 812, 814, 816, and 816 are sent at varying power levels. The first transmission 812 and the fourth transmission 818 carried critical data, and therefore no power backoff was instituted. The second and third transmissions (e.g. 814 and 816, respectively) were not critical, and the SAR controller controlled the baseband modem to transmit them at a first power backoff and a second power backoff, respectively. The resulting TA-SAR for transmissions 812, 814, 816, and 818 is 820. It is apparent that the resulting TA-SAR 820 is reduced compared to 810.

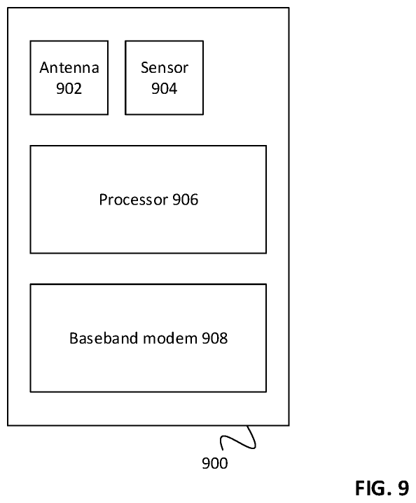

FIG. 9 depicts a computing device 900, according to the second aspect of the disclosure. The computer device 900 may include an antenna 902. The computing device may include a sensor 904, configured to detect a human body part within a proximity of the antenna and to generate sensor data representing the detected proximity. The computing device 900 includes a processor 906, configured to, if the sensor data are outside of a range, operate according to a first operational mode; and if the sensor data are within the range, operate according to a second operational mode. In this manner, operating according to the first operational mode may include the processor 906 classifying data to be transmitted on the antenna 902 as data of a first type or a second type; and transmitting the data of the first type a first power level and transmitting the data of the second type at a second power level, different from the first power level. It is noted that the processor 906 may be implemented as a single processor or as multiple processors. For example, the classification step may be configured as part of a SAR controller as disclosed herein. In this manner, the SAR controller may control as baseband modem (which may include its own processor or processors) to transmit the data.

As disclosed herein, the first type of data may be critical data, and the second type of data may be non-critical data.

The first power level may be a maximum power level minus a first value, and the second power level may be the maximum power level minus a second value. In this manner, the first value may be less than the second value. In so doing, non-critical data undergo a greater power backoff than critical data.

The sensor 904 as disclosed herein according to the second aspect of the disclosure may be a proximity sensor, configured to detect a proximity of a human body part and to generate the sensor data representing the detected proximity. This may be a capacitive or inductive proximity sensor, or it may be another sensor type which may nevertheless detect human body part proximity, such as a baseband modem or transceiver or other radiofrequency device that may detect reflections of radiofrequency signals from a nearby human body part. Alternatively or additionally, the sensor may be an accelerometer, which may be configured to detect a proximity of a human body part by detecting movement and to generate the sensor data representing the detected proximity.

According to a third aspect of the disclosure, pre-transmission configuration data that is extrinsic to link quality (LQ) post transmission statistics and grading may be used in determining the LQ. Such data may include, but is not limited to, power limitations per chain, or TA-SAR energy status per chain.

The transmit LQ may use these extrinsic data per antenna chain to optimize the LQ rate determination. Data such as a transmit power difference over a predetermined threshold may be utilized in the LQ search cycle, and based on the results, the computing device may decide whether to start a search in a single input single output (SISO) mode rather than in multiple input multiple output (MIMO) mode. Alternatively, the computing device may use an available TA-SAR energy budget per chain to balance the TA-SAR energies over the chains and reduce or eliminate power backoffs. With any change of power limits in the system, regardless of the chain balancing trigger, the LQ manager may recalculate and search the appropriate rate, such as to reduce LQ rection delay, rather than waiting for subsequent transmit statistics.

The transmit power control (TPC) may be configured in software or hardware, and which may be carried out by any processor in the computing device, whether a processors solely for managing power control, or in a processor that performs other functions, e.g. modulation/demodulation, application processing, etc. The TPC may be synonymous with the SAR controller that is otherwise disclosed herein throughout. The TPC may reduce power based on the traffic category throughput requirement and/or the congestion level available duty-cycle. The TPC may attempt a search cycle using power backoff and then gather statistics on the attempted cycle. If a result of this attempted search cycle provides adequate throughput (e.g. satisfies a relevant minimum level of throughput), the TPC may set the transmit power with power backoff as the new transmission power, and the proximity sensor (e.g. body part sensor) may be set off if the new power is below that of the relevant SAR tables.

Examples of data that may be considered include, but are not limited to, SAR limits per chain, body part sensor (BPS) proximity status per chain, or multi-communication co-existence limits per chain (e.g., Bluetooth, TA-SAR power backoff per chain, and/or TA-SAR integral energy budget status per chain).

In a first configuration, the TPC receives transmit power per chain (e.g. such as chains in a MIMO configuration). Some chains may be permitted to transmit at a maximum transmit power, while another chain or other chains may have a lower transmit power, such as due to a TA-SAR power backoff. The TPC may calculate the difference in transmit power of the chains, and if a difference in power backoff is greater chain a predetermined threshold (ChainPwrDiffTh) (e.g., if the difference is outside of a range), the LQ may trigger a search (e.g., a search for new LQ parameters). The LQ may decide based on a predetermined range and/or a predetermined threshold to start a search from SISO on the better chain (e.g., on a chain having a greater transmit power or a chain having a greater integral transmit power budget).

If a TAS chain's integral transmit power budget is close to a protection threshold (e.g. if under a TA-SAR schema, the chain has exhausted or nearly exhausted its transmit power budget), and if another chain has a greater available integral transmit power budget, the LQ may force SISO on the better chain until the integral levels on the better chain and at least one other chain (but potentially multiple or all other chains) are in balance. Using these techniques, it may be possible to prevent or at least limit power backoffs.

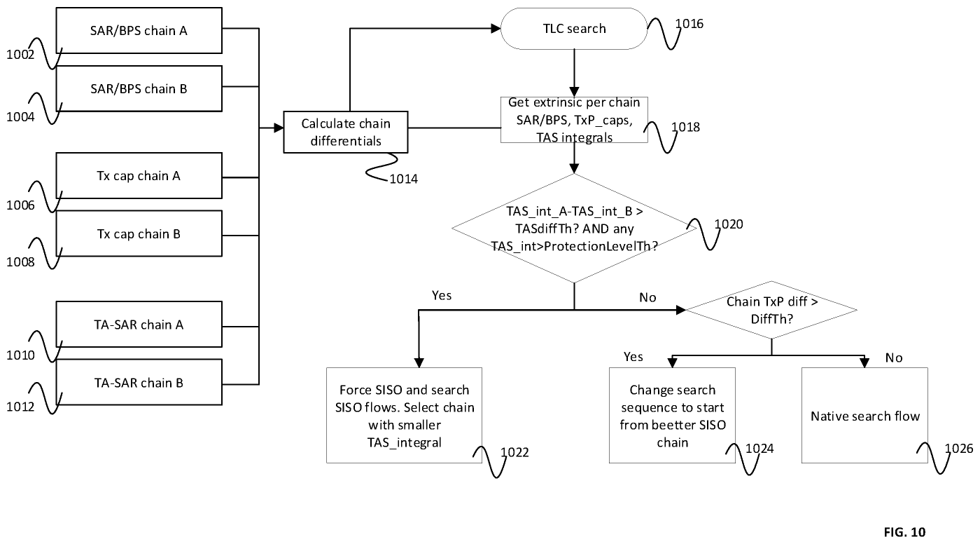

FIG. 10 depicts a flowchart of the chain grading power control procedure disclosed herein. The TPC may receive SAR information and or proximity sensor (e.g. body part sensor) information per chain (depicted as 1002 for chain A and 1004 for chain B); a transmission cap or upper transmit power limit per chain (depicted as 1006 for chain A and 1008 for chain B); TA-SAR (average transmit power according to a TA-SAR schema) (depicted as 1010 for chain A and 1012 for chain B), or any of these. The TPC may calculate chain differentials (e.g. a difference in the above factors among the various chains). If the TPC detects a difference in a chain differential (e.g. if a power backoff is instituted on one chain but not another), the TPC will trigger a new LQ rate search cycle 1016.

Using the extrinsic per chain data 1018, and if TA-SAR is enabled/supported, and the credit energy (the remaining integral transmit power budget) between the chains is over a threshold (e.g. outside of a range), and if the remaining integral transmit power budget for any chain is close to a protection level (e.g., close to a maximum amount permitted based on the SAR regulation) 1020, the TPC may force SISO for next transmission 1022, using the chain with more TAS energy credit. Otherwise, if the remaining integral transmit power budget for any chain is not close to a protection level, but if the transmission power difference between chains is over a threshold (e.g. outside of a range), the TPC may trigger a search cycle and start a SISO search on a less restricted chain 1024. Otherwise, the TPC may make no changes and rely on the device's native workflow 1026.

In an additional, optional configuration, in any change of power limits in the system, regardless of chain balancing, may trigger the LQ to recalculate and determine the appropriate rate to reduce LQ reaction delay, without waiting for transmit posterior statistics.

Although the details of the LQ algorithm for determining the actual transmit rate are beyond the scope of this disclosure, the LQ may determine the rate using, for example, “direct estimation”, “search”, a combination of direct estimation and search, or any other scheme.

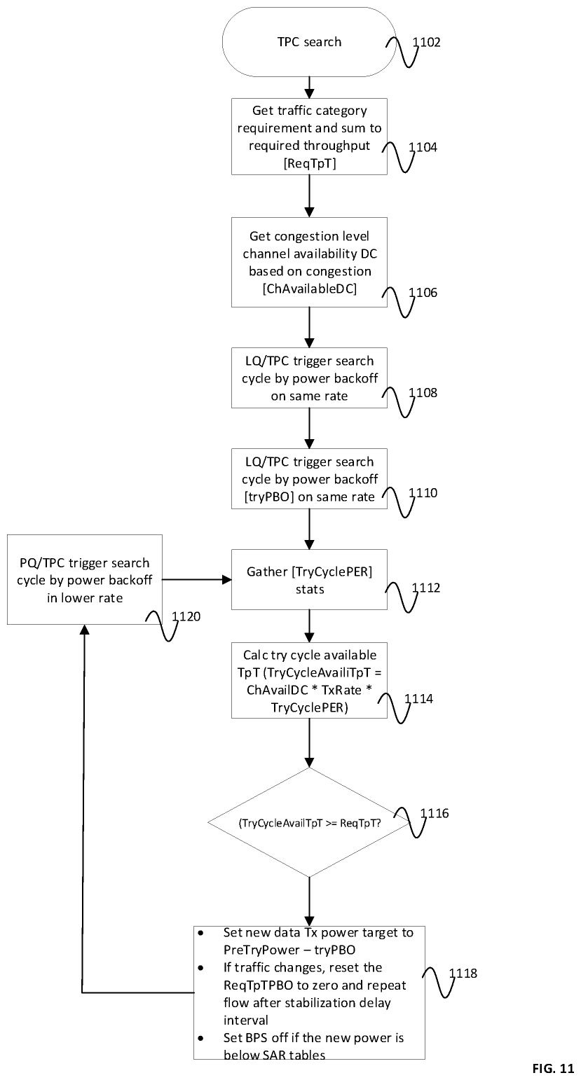

According to another configuration of the third aspect of the disclosure, the TPC may reduce power under certain conditions/according to certain procedures. FIG. 11 depicts a flowchart for TPC power reduction according to the second configuration of the third aspect of the disclosure. In this figure, the TPC performs a TPC search as described herein 1102. The TPC obtains traffic category requirements and uses these to determine the required throughput 1104 (ReqTpT). The TPC receives congestion level, the last transmissions goodput statistics, calculates channel availability DC based on congestion (ChAvailableDC) 1106. The TPC performs an LQ/TPC trigger search cycle by power backoff (tryPBO) on the same rate 1108. The LQ/TPC triggers a search cycle by power backoff [tryPBO] on the same rate 1110. The TPC obtains (TryCyclePER) statistics 1112. The LQ may calculate attempts cycles available as TpT (TryCycleAvailTpT=ChAvailableDC*TxRate*TryCyclePER) 1114. If TryCycleAvailTpT>=ReqTpT 1116, the TPC may set a new data Tx power target to PreTryPower—tryPBO 1118; if the traffic changes reset theReqTpT power backoff to zero and repeat the workflow (the flowchart in FIG. 11) after a stabilization delay interval 1118; and turn the BPS off if the new power is below that of the SAR tables 1118. In a further optional configuration, the TPC can attempt a further search cycle in a lower power back off rate 1120.

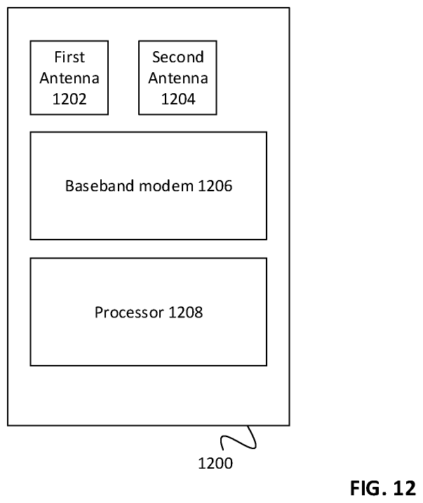

FIG. 12 depicts a computing device 1200 according to the third aspect of the disclosure. The computing device may include a first antenna 1202 and a second antenna 1204. The computing device may include a baseband modem 1206, configured to simultaneously or concurrently transmit on the first antenna 1202 and the second antenna 1204. The computing device may include a processor 1208, configured to determine a transmission power difference, wherein the transmission power difference is a difference between a first transmission power of a transmission on the first antenna 1202 and a second transmission power of a transmission on the second antenna 1204. If the transmission power difference is outside of a range, the processor 1208 may be configured to determine a new transmission rate for a transmission on the first antenna or the second antenna.

In an optional configuration, if the transmission power difference is within the range, the processor 1208 may be configured to control the baseband modem to transmit at a previous transmission rate. The processor may be optionally further configured to determine a cumulative transmit power difference, wherein the cumulative transmit power difference is a difference between a first cumulative transmit power on a first antenna over a duration and a second cumulative transmit power of a second antenna over the duration; and wherein if the cumulative transmit power difference is outside of a first range, and if first cumulative transmit power is outside of a second range, the processor may be configured to control the baseband modem to transmit on the second antenna.

In a further optional configuration, if the cumulative transmit power difference is outside of the first range, and if first cumulative transmit power is outside of the second range, the processor 1208 may be further configured to control the baseband modem 1206 to discontinue transmission on the first antenna.

In a further optional configuration, which may be combined with any of the previous configuration, if either the cumulative transmit power difference is within the first range, or if the first cumulative transmit power is within the second range, and a difference between a maximum transmit power of the first antenna and a maximum transmit power of the second antenna is outside of a third range, the processor is further configured to determine a new transmission rate for a transmission on the first antenna or the second antenna. Optionally, if either the cumulative transmit power difference is within the first range, or if the first cumulative transmit power is within the second range, and a difference between a maximum transmit power of the first antenna and a maximum transmit power of the second antenna is outside of a third range, the processor 1208 may be further configured to control the baseband modem to transmit on an antenna of the first antenna or the second antenna having a greatest maximum transmit power.

The processor may be configured to receive the maximum transmit power of the first antenna and the maximum transmit power of the second antenna from a transmit power management controller. The processor may be configured to receive first proximity sensor data from a first proximity sensor, configured to detect a proximity of a human body part in a vicinity of the first antenna; wherein the processor is configured to receive second proximity sensor data from a second proximity sensor, configured to detect a proximity of a human body part in a vicinity of the second antenna; and wherein the processor is configured to determine the maximum transmit power of the first antenna and the maximum transmit power of the second transmit antenna based on the first proximity sensor data and the second proximity sensor data.

While the above descriptions and connected figures may depict components as separate elements, skilled persons will appreciate the various possibilities to combine or integrate discrete elements into a single element. Such may include combining two or more circuits for form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

Further aspects of the disclosure will be described by way of example.

In Example 1, a computing device including: an interface to a first antenna and a second antenna; and a processor, configured to perform an antenna hopping operation, wherein the antenna hopping operation includes: calculating a first transmit power value representing a transmit power on the first antenna during a transmit period; and when the first transmit power value reaches a threshold, controlling a baseband modem to begin a second transmit period on the second antenna.

In Example 2, the computing device of Example 1, further including: the first antenna; and the second antenna.

In Example 3, the computing device of Example 1 or 2, wherein the antenna hopping operation further includes, when the first transmit power value reaches the threshold, controlling the baseband modem to discontinue transmission on the first antenna during the second transmit period.

In Example 4, the computing device of any one of Examples 1 to 3, wherein the antenna hopping operation further includes the processor calculating a second transmit power value representing a transmit power on the second antenna during the second transmit period; and when the second average transmit power reaches a threshold, beginning a third transmit period on the first antenna or a third antenna.

In Example 5, the computing device of Example 4, wherein the antenna hopping operation further includes, when the second transmit power value reaches the threshold, controlling the baseband modem to discontinue transmission on the second antenna during the third transmit period.

In Example 6, the computing device of any one of Examples 1 to 5, wherein the first transmit power value is a mean of transmit power on the first antenna relative to time during the first transmit period; and wherein the second transmit power value is a mean of transmit power on the second antenna relative to time during the second transmit period;

In Example 7, the computing device of any one of Examples 1 to 6, further including a plurality of second antennas, wherein the second antenna is a second antenna of the plurality of second antennas; wherein the processor is further configured to successively begin a transmit period on each antenna of the plurality of second antennas; calculate an transmit power value on the each antenna of the plurality of second antennas; and when the transmit power value on the each antenna of the plurality of second antennas reaches the threshold, to discontinue transmission on the each antenna of the plurality of second antennas and to begin a transit period on another antenna.

In Example 8, the computing device of any one of Examples 1 to 7, further including a proximity sensor, configured to detect a proximity of the first antenna and to generate proximity sensor data representing the detected proximity of the first antenna; wherein if the proximity sensor data is outside of a range, the processor is configured to operate according to a first operational mode; wherein the processor is configured to, if the proximity sensor data is within the range, operate according to a second operational mode; wherein operating according to the first operational mode includes performing the antenna hopping operation; and wherein operating according to the second operational mode includes discontinuing the antenna hopping operation.

In Example 9, the computing device of any one of Examples 1 to 8, wherein the processor is configured to transmit at a maximum power during the first transmit period and the second transmit period.

In Example 10, the computing device of any one of Examples 1 to 9, further including a multiplexer, configured to selectively connect the processor to the first antenna or the second antenna, and wherein transmitting on the first antenna includes controlling the multiplexer to connect the processor to the first antenna, and wherein transmitting on the second antenna includes controlling the multiplexer to connect the processor to the second antenna.

In Example 11, the computing device of any one of Examples 1 to 10, further including a baseband modem, wherein transmitting during the first transmit period includes the processor controlling the baseband modem to transmit on the first antenna, and wherein transmitting during the second transmit period includes the processor controlling the baseband modem to transmit on the second antenna.

In Example 12. A non-transitory computer readable medium including instructions which, if executed by one or more processors, cause the one or more processors to: perform an antenna hopping operation, wherein the antenna hopping operation includes: calculating a first transmit power value representing a transmit power on the first antenna during a transmit period; and when the first transmit power value reaches a threshold, controlling a baseband modem to begin a second transmit period on the second antenna.

In Example 13, the non-transitory computer readable medium of Example 12, wherein the antenna hopping operation further includes, when the first transmit power value reaches the threshold, controlling the baseband modem to discontinue transmission on the first antenna during the second transmit period.

In Example 14, the non-transitory computer readable medium of any one of Examples 12 to 13, wherein the antenna hopping operation further includes the processor calculating a second transmit power value representing a transmit power on the second antenna during the second transmit period; and when the second average transmit power reaches a threshold, beginning a third transmit period on the first antenna or a third antenna.

In Example 15, the non-transitory computer readable medium of Example 14, wherein the antenna hopping operation further includes, when the second transmit power value reaches the threshold, controlling the baseband modem to discontinue transmission on the second antenna during the third transmit period.

In Example 16, the non-transitory computer readable medium of any one of Examples 12 to 15, wherein the first transmit power value is a mean of transmit power on the first antenna relative to time during the first transmit period; and wherein the second transmit power value is a mean of transmit power on the second antenna relative to time during the second transmit period;

In Example 17, the non-transitory computer readable medium of any one of Examples 12 to 16, wherein the instructions are further configured to cause the processor to successively begin a transmit period on each antenna of a plurality of second antennas; calculate a transmit power value on the each antenna of the plurality of second antennas; and when the transmit power value on the each antenna of the plurality of second antennas reaches the threshold, to discontinue transmission on the each antenna of the plurality of second antennas and to begin a transit period on another antenna.

In Example 18, the non-transitory computer readable medium of any one of Examples 12 to 17, wherein the instructions are further configured to cause the one or more processors to determine whether proximity sensor data representing a detected proximity of the first antenna is outside of a range; wherein if the proximity sensor data is outside of the range, the instructions are configured to cause the one or more processors to operate according to a first operational mode; wherein the instructions are configured to, if the proximity sensor data is within the range, cause the one or more processors to operate according to a second operational mode; wherein operating according to the first operational mode includes performing the antenna hopping operation; and wherein operating according to the second operational mode includes discontinuing the antenna hopping operation.

In Example 19, the non-transitory computer readable medium of any one of Examples 12 to 18, wherein the instructions are further configured to cause the one or more processors to control a transceiver to transmit at a maximum power during the first transmit period and the second transmit period.

In Example 20, the non-transitory computer readable medium of any one of Examples 12 to 19, wherein transmitting on the first antenna includes controlling a multiplexer to connect the processor to the first antenna, and wherein transmitting on the second antenna includes controlling the multiplexer to connect the processor to the second antenna.

In Example 21, the non-transitory computer readable medium of any one of Examples 12 to 20, wherein transmitting during the first transmit period includes the processor controlling the baseband modem to transmit on the first antenna, and wherein transmitting during the second transmit period includes the processor controlling the baseband modem to transmit on the second antenna.

In Example 22. A method of performing an antenna hopping operation, including: calculating a first transmit power value representing a transmit power on the first antenna during a transmit period; and when the first transmit power value reaches a threshold, controlling a baseband modem to begin a second transmit period on the second antenna.

In Example 23, the method of Example 22, wherein the antenna hopping operation further includes, when the first transmit power value reaches the threshold, controlling the baseband modem to discontinue transmission on the first antenna during the second transmit period.

In Example 24, the method of Example 22 or 23, wherein the antenna hopping operation further includes calculating a second transmit power value representing a transmit power on the second antenna during the second transmit period; and when the second average transmit power reaches a threshold, beginning a third transmit period on the first antenna or a third antenna.

In Example 25, the method of Example 24, wherein the antenna hopping operation further includes, when the second transmit power value reaches the threshold, controlling the baseband modem to discontinue transmission on the second antenna during the third transmit period.

In Example 26, the method of any one of Examples 22 to 25, wherein the first transmit power value is a mean of transmit power on the first antenna relative to time during the first transmit period; and wherein the second transmit power value is a mean of transmit power on the second antenna relative to time during the second transmit period;

In Example 27, the method of any one of Examples 22 to 26, further including a plurality of second antennas, wherein the second antenna is a second antenna of the plurality of second antennas; further including successively beginning a transmit period on each antenna of the plurality of second antennas; calculating an transmit power value on the each antenna of the plurality of second antennas; and when the transmit power value on the each antenna of the plurality of second antennas reaches the threshold, discontinuing transmission on the each antenna of the plurality of second antennas and to begin a transit period on another antenna.

In Example 28, the method of any one of Examples 22 to 27, further including a proximity sensor, configured to detect a proximity of the first antenna and to generate proximity sensor data representing the detected proximity of the first antenna; wherein if the proximity sensor data is outside of a range, the processor is configured to operate according to a first operational mode; wherein the processor is configured to, if the proximity sensor data is within the range, operate according to a second operational mode; wherein operating according to the first operational mode includes performing the antenna hopping operation; and wherein operating according to the second operational mode includes discontinuing the antenna hopping operation.

In Example 29, the method of any one of Examples 22 to 28, wherein the processor is configured to transmit at a maximum power during the first transmit period and the second transmit period.

In Example 30, the method of any one of Examples 22 to 29, further including a multiplexer, configured to selectively connect the processor to the first antenna or the second antenna, and wherein transmitting on the first antenna includes controlling the multiplexer to connect the processor to the first antenna, and wherein transmitting on the second antenna includes controlling the multiplexer to connect the processor to the second antenna.

In Example 31, the method of any one of Examples 22 to 30, further including a baseband modem, wherein transmitting during the first transmit period includes the processor controlling the baseband modem to transmit on the first antenna, and wherein transmitting during the second transmit period includes the processor controlling the baseband modem to transmit on the second antenna.

In Example 32, a computing device including: a sensor, configured to detect a human body part within a proximity of an antenna and to generate sensor data representing the detected proximity; a processor, configured to: if the sensor data are outside of a range, operate according to a first operational mode; and if the sensor data are within the range, operate according to a second operational mode; wherein operating according to the first operational mode includes the processor classifying data to be transmitted on the antenna as data of a first type or a second type; transmitting the data of the first type a first power level and transmitting the data of the second type at a second power level, different from the first power level.

In Example 33, the computing device of Example 32, further including the antenna.

In Example 34, the computing device of Example 32 or 33, wherein the first type are critical data, and the second type are non-critical data.

In Example 35, the computing device of any one of Examples 32 to 34, wherein the first power level is a maximum power level minus a first value, and the second power level is the maximum power level minus a second value; and wherein the first value is less than the second value.

In Example 36, the computing device of any one of Examples 32 to 35, wherein the sensor is a proximity sensor, configured to detect a proximity of a human body part and to generate the sensor data representing the detected proximity.

In Example 37, the computing device of any one of Examples 32 to 35, wherein the sensor is an accelerometer, configured to detect a proximity of a human body part by detecting movement and to generate the sensor data representing the detected proximity.

In Example 38, the computing device of any one of Examples 32 to 35, wherein the sensor includes the antenna and a baseband modem, configured to detect a human body part in a vicinity of the sensor based on a reflection from the human body part of a radiofrequency signal.

In Example 39, the computing device of any one of Examples 32 to 35, wherein the sensor is configured to determine whether the computing device is connected to a dock, or whether a lid of the computing device is closed.

In Example 40, the computing device of any one of Examples 32 to 39, wherein the first type are critical data, and the second type are non-critical data; wherein the data include Physical Uplink Control Channel (PUCCH) data, and wherein the processor classifying data as data of the first type or the second type includes the processor classifying PUCCH type 1, 1a, and 1b data as data of the first type, and PUCCH type 2, 2a, and 2b data as data of the second type.

In Example 41, the computing device of any one of Examples 32 to 40, wherein the first type are critical data, and the second type are non-critical data; wherein the data include Physical Uplink Shared Channel (PUSCH) data including Radio Resource Control (RRC) signaling messages, application data, user data, or uplink control information; and wherein the processor classifying data to be transmitted on the antenna as data of a first type or a second type includes the processor classifying the RRC signaling messages and uplink control information as data of the first type and classifying application data and/or user data as data of the second type.

In Example 42, the computing device of any one of Examples 32 to 41, wherein the first power level is a maximum power level.

In Example 43, the computing device of any one of Examples 32 to 41, wherein the first power level is a power level between the maximum power level and zero power, and greater than the second power level.

In Example 44, the computing device of any one of Examples 32 to 43, wherein the second power level is zero power.

In Example 45, the computing device of Example 44, wherein transmitting the data of the second type at zero power includes skipping the scheduled transmission to reduce a time average transmit power level.

In Example 46, the computing device of Example 44, wherein transmitting the data of the second type at zero power includes skipping a scheduled transmission of the second type channel for reducing an overall time average transmit power level.

In Example 47, the computing device of any one of Examples 32 to 45, wherein the second power level is a power level between the maximum power level and zero power, and less than the first power level.

In Example 48, a non-transitory computer readable medium, including instructions which, if executed, cause one or more processors to: determine whether sensor data are within a range, wherein the sensor is configured to detect a human body part within a proximity of an antenna and to generate sensor data representing the detected proximity; if the sensor data are outside of a range, operate according to a first operational mode; and if the sensor data are within the range, operate according to a second operational mode; wherein operating according to the first operational mode includes classifying data to be transmitted on the antenna as data of a first type or a second type; transmitting the data of the first type a first power level and transmitting the data of the second type at a second power level, different from the first power level.

In Example 49, the non-transitory computer readable medium of Example 48, wherein the first type are critical data, and the second type are non-critical data.

In Example 50, the non-transitory computer readable medium of any one of Examples 48 to 49, wherein the first power level is a maximum power level minus a first value, and the second power level is the maximum power level minus a second value; and wherein the first value is less than the second value.

In Example 51, the non-transitory computer readable medium of any one of Examples 48 to 50, wherein the sensor is a proximity sensor, configured to detect a proximity of a human body part and to generate the sensor data representing the detected proximity.

In Example 52, the non-transitory computer readable medium of any one of Examples 48 to 50, wherein the sensor is an accelerometer, configured to detect a proximity of a human body part by detecting movement and to generate the sensor data representing the detected proximity.

In Example 53, the non-transitory computer readable medium of any one of Examples 48 to 50, wherein the sensor includes the antenna and a baseband modem, configured to detect a human body part in a vicinity of the sensor based on a reflection from the human body part of a radiofrequency signal.

In Example 54, the non-transitory computer readable medium of any one of Examples 48 to 50, wherein the sensor is configured to determine whether the computing device is connected to a dock, or whether a lid of the computing device is closed.

In Example 55, the non-transitory computer readable medium of any one of Examples 48 to 54, wherein the first type are critical data, and the second type are non-critical data; wherein the data include Physical Uplink Control Channel (PUCCH) data, and wherein the processor classifying data as data of the first type or the second type includes the processor classifying PUCCH type 1, 1a, and 1b data as data of the first type, and PUCCH type 2, 2a, and 2b data as data of the second type.

In Example 56, the non-transitory computer readable medium of any one of Examples 48 to 55, wherein the first type are critical data, and the second type are non-critical data; wherein the data include Physical Uplink Shared Channel (PUSCH) data including Radio Resource Control (RRC) signaling messages, application data, user data, or uplink control information; and wherein the processor classifying data to be transmitted on the antenna as data of a first type or a second type includes the processor classifying the RRC signaling messages and uplink control information as data of the first type and classifying application data and/or user data as data of the second type.

In Example 57, the non-transitory computer readable medium of any one of Examples 48 to 56, wherein the first power level is a maximum power level.

In Example 58, the non-transitory computer readable medium of any one of Examples 48 to 56, wherein the first power level is a power level between the maximum power level and zero power, and greater than the second power level.

In Example 59, the non-transitory computer readable medium of any one of Examples 48 to 58, wherein the second power level is zero power.

In Example 60, the non-transitory computer readable medium of Example 59, wherein transmitting the data of the second type at zero power includes skipping the scheduled transmission to reduce a time average transmit power level.

In Example 61, the non-transitory computer readable medium of Example 59, wherein transmitting the data of the second type at zero power includes skipping a scheduled transmission of the second type channel for reducing an overall time average transmit power level.

In Example 62, the non-transitory computer readable medium of any one of Examples 48 to 60, wherein the second power level is a power level between the maximum power level and zero power, and less than the first power level.

In Example 63, a method including: determining whether sensor data are inside a range, wherein the sensor data represent detection of a human body part within a proximity of an antenna; if the sensor data are outside of a range, operate according to a first operational mode; and if the sensor data are within the range, operate according to a second operational mode; wherein operating according to the first operational mode includes the processor classifying data to be transmitted on the antenna as data of a first type or a second type; transmitting the data of the first type a first power level and transmitting the data of the second type at a second power level, different from the first power level.

In Example 64, the method of Example 63, further including the antenna.

In Example 65, the method of Example 63 or 64, wherein the first type are critical data, and the second type are non-critical data.

In Example 66, the method of any one of Examples 63 to 65, wherein the first power level is a maximum power level minus a first value, and the second power level is the maximum power level minus a second value; and wherein the first value is less than the second value.

In Example 67, the method of any one of Examples 63 to 66, wherein the sensor is a proximity sensor, configured to detect a proximity of a human body part and to generate the sensor data representing the detected proximity.

In Example 68, the method of any one of Examples 63 to 66, wherein the sensor is an accelerometer, configured to detect a proximity of a human body part by detecting movement and to generate the sensor data representing the detected proximity.

In Example 69, the method of any one of Examples 63 to 66, wherein the sensor includes the antenna and a baseband modem, configured to detect a human body part in a vicinity of the sensor based on a reflection from the human body part of a radiofrequency signal.

In Example 70, the method of any one of Examples 63 to 66, wherein the sensor is configured to determine whether the computing device is connected to a dock, or whether a lid of the computing device is closed.

In Example 71, the method of any one of Examples 63 to 70, wherein the first type are critical data, and the second type are non-critical data; wherein the data include Physical Uplink Control Channel (PUCCH) data, and wherein the processor classifying data as data of the first type or the second type includes the processor classifying PUCCH type 1, 1a, and 1b data as data of the first type, and PUCCH type 2, 2a, and 2b data as data of the second type.

In Example 72, the method of any one of Examples 63 to 71, wherein the first type are critical data, and the second type are non-critical data; wherein the data include Physical Uplink Shared Channel (PUSCH) data including Radio Resource Control (RRC) signaling messages, application data, user data, or uplink control information; and wherein the processor classifying data to be transmitted on the antenna as data of a first type or a second type includes the processor classifying the RRC signaling messages and uplink control information as data of the first type and classifying application data and/or user data as data of the second type.

In Example 73, the method of any one of Examples 63 to 72, wherein the first power level is a maximum power level.

In Example 74, the method of any one of Examples 63 to 72, wherein the first power level is a power level between the maximum power level and zero power, and greater than the second power level.

In Example 75, the method of any one of Examples 63 to 74, wherein the second power level is zero power.

In Example 76, the method of Example 75, wherein transmitting the data of the second type at zero power includes skipping the scheduled transmission to reduce a time average transmit power level.

In Example 77, the method of Example 75, wherein transmitting the data of the second type at zero power includes skipping a scheduled transmission of the second type channel for reducing an overall time average transmit power level.

In Example 78, the method of any one of Examples 63 to 76, wherein the second power level is a power level between the maximum power level and zero power, and less than the first power level.

In Example 79, a computing device, including: a baseband modem, configured to instruct to simultaneously or concurrently transmit on a first antenna and a second antenna; and a processor, configured to: determine a transmission power difference, wherein the transmission power difference is a difference between a first transmission power of a transmission on the first antenna and a second transmission power of a transmission on the second antenna; if the transmission power difference is outside of a range, determine a new transmission rate for a transmission on the first antenna or the second antenna.

In Example 80, the computing device of Example 79, further including: the first antenna; and the second antenna.

In Example 81, the computing device of Example 79 or 80, wherein if the transmission power difference is within the range, the processor is configured to control the baseband modem to transmit at a previous transmission rate.

In Example 82, the computing device of any one of Examples 79 to 81, wherein if either the cumulative transmit power difference is within the first range, or if the first cumulative transmit power is within the second range, and a difference between a maximum transmit power of the first antenna and a maximum transmit power of the second antenna is outside of a third range, the processor is further configured to determine a new transmission rate for a transmission on the first antenna or the second antenna.

In Example 83, the computing device of Example 82, wherein if either the cumulative transmit power difference is within the first range, or if the first cumulative transmit power is within the second range, and a difference between a maximum transmit power of the first antenna and a maximum transmit power of the second antenna is outside of a third range, the processor is further configured to control the baseband modem to transmit on an antenna of the first antenna or the second antenna having a greatest maximum transmit power.

In Example 84, the computing device of Example 83, wherein the processor is configured to receive the maximum transmit power of the first antenna and the maximum transmit power of the second antenna from a transmit power management controller.

In Example 85, the computing device of any one of Examples 79 to 84, wherein the processor is further configured to determine a cumulative transmit power difference, wherein the cumulative transmit power difference is a difference between a first cumulative transmit power on a first antenna over a duration and a second cumulative transmit power of a second antenna over the duration; wherein if the cumulative transmit power difference is outside of a first range, and if first cumulative transmit power is outside of a second range, the processor is configured to control the baseband modem to transmit on the second antenna.

In Example 86, the computing device of Example 85, wherein if the cumulative transmit power difference is outside of the first range, and if first cumulative transmit power is outside of the second range, the processor is further configured to control the baseband modem to discontinue transmission on the first antenna.

In Example 87, the computing device of any one of Examples 79 to 86, wherein the processor is configured to receive first proximity sensor data from a first proximity sensor, configured to detect a proximity of a human body part in a vicinity of the first antenna;

wherein the processor is configured to receive second proximity sensor data from a second proximity sensor, configured to detect a proximity of a human body part in a vicinity of the second antenna; and wherein the processor is configured to determine the maximum transmit power of the first antenna and the maximum transmit power of the second transmit antenna based on the first proximity sensor data and the second proximity sensor data.

In Example 88, the computing device of any one of Examples 79 to 87, wherein the cumulative transmit power is a cumulative transmit power according to a time-averaging specific absorption rate calculation, related to an amount of accumulated energy over time.

In Example 89, a computing device, including: a processor, configured to: determine a required throughput for data to be wirelessly sent by the computing device; select a candidate power backoff for transmission of the data; determine a throughput at the candidate power backoff; if the expected throughout is less than the required throughout, operate according to a first operational mode; and if the expected throughout is greater than the required throughout, operate according to a second operational mode.

In Example 90, the computing device of Example 89, wherein the processor is configured to determine the required throughput based on one or more data traffic categories.

In Example 91, the computing device of Example 89 or 90, wherein processor determining the required throughput based on the one or more data traffic categories includes the processor determining a required throughput for a plurality of data traffic categories and summing the required throughput for the plurality of data traffic categories.

In Example 92, the computing device of any one of Examples 89 to 91, wherein processor determining the expected throughput includes the processor determining the expected throughput based on any of channel availability, transmission rate, or packet error rate.

In Example 93, the computing device of Example 92, wherein processor determining the expected throughput includes the processor determining the expected throughput as a product of channel availability, transmission rate, and packet error rate.

In Example 94, the computing device of any one of Examples 89 to 93, wherein operating according to the first operational mode includes performing a new transmit power search.

In Example 95, the computing device of any one of Examples 89 to 94, wherein operating according to the first operational mode includes selecting a new candidate power backoff.

In Example 96, the computing device of any one of Examples 89 to 95, wherein operating according to the second operational mode includes transmitting a data packet according to the candidate power backoff.

In Example 97, the computing device of any one of Examples 89 to 96, wherein the error rate is a packet error rate.

In Example 98, a non-transitory computer readable medium, including instructions which, if executed, cause one or more processors to: determine a transmission power difference, wherein the transmission power difference is a difference between a first transmission power of a transmission on the first antenna and a second transmission power of a transmission on the second antenna; if the transmission power difference is outside of a range, determine a new transmission rate for a transmission on the first antenna or the second antenna.

In Example 99, the non-transitory computer readable medium of Example 98, wherein if the transmission power difference is within the range, the processor is configured to control the baseband modem to transmit at a previous transmission rate.

In Example 100, the non-transitory computer readable medium of any one of Examples 98 to 99, wherein if either the cumulative transmit power difference is within the first range, or if the first cumulative transmit power is within the second range, and a difference between a maximum transmit power of the first antenna and a maximum transmit power of the second antenna is outside of a third range, the instructions are further configured to cause the one or more processors to determine a new transmission rate for a transmission on the first antenna or the second antenna.

In Example 101, the non-transitory computer readable medium of Example 100, wherein if either the cumulative transmit power difference is within the first range, or if the first cumulative transmit power is within the second range, and a difference between a maximum transmit power of the first antenna and a maximum transmit power of the second antenna is outside of a third range, the instructions are further configured to cause the one or more processors to control the baseband modem to transmit on an antenna of the first antenna or the second antenna having a greatest maximum transmit power.

In Example 102, the non-transitory computer readable medium of Example 101, wherein the instructions are further configured to cause the one or more processors to receive the maximum transmit power of the first antenna and the maximum transmit power of the second antenna from a transmit power management controller.

In Example 103, the non-transitory computer readable medium of any one of Examples 98 to 102, wherein the instructions are further configured to cause the one or more processors to: determine a cumulative transmit power difference, wherein the cumulative transmit power difference is a difference between a first cumulative transmit power on a first antenna over a duration and a second cumulative transmit power of a second antenna over the duration; wherein if the cumulative transmit power difference is outside of a first range, and if first cumulative transmit power is outside of a second range, the processor is configured to control the baseband modem to transmit on the second antenna.

In Example 104, the non-transitory computer readable medium of Example 103, wherein if the cumulative transmit power difference is outside of the first range, and if first cumulative transmit power is outside of the second range, the instructions are further configured to cause the one or more processors to control the baseband modem to discontinue transmission on the first antenna.

In Example 105, the non-transitory computer readable medium of any one of Examples 98 to 104, wherein the instructions are further configured to cause the one or more processors to receive first proximity sensor data from a first proximity sensor, configured to detect a proximity of a human body part in a vicinity of the first antenna; wherein the instructions are further configured to cause the one or more processors to receive second proximity sensor data from a second proximity sensor, configured to detect a proximity of a human body part in a vicinity of the second antenna; and wherein the instructions are further configured to cause the one or more processors to determine the maximum transmit power of the first antenna and the maximum transmit power of the second transmit antenna based on the first proximity sensor data and the second proximity sensor data.

In Example 106, the non-transitory computer readable medium of any one of Examples 98 to 105, wherein the cumulative transmit power is a cumulative transmit power according to a time-averaging specific absorption rate calculation, related to an amount of accumulated energy over time.

In Example 107, a non-transitory computer readable medium, including instructions which, if executed by one or more processors, cause the one or more processors to: determine a required throughput for data to be wirelessly sent by the computing device; select a candidate power backoff for transmission of the data; determine a throughput at the candidate power backoff; if the expected throughout is less than the required throughout, operate according to a first operational mode; and if the expected throughout is greater than the required throughout, operate according to a second operational mode.

In Example 108, the non-transitory computer readable medium of Example 107, wherein the processor is configured to determine the required throughput based on one or more data traffic categories.

In Example 109, the non-transitory computer readable medium of Example 107 or 108, wherein the processor determining the required throughput based on the one or more data traffic categories includes the processor determining a required throughput for a plurality of data traffic categories and summing the required throughput for the plurality of data traffic categories.

In Example 110, the non-transitory computer readable medium of any one of Examples 107 to 109, wherein the processor determining the expected throughput includes the processor determining the expected throughput based on any of channel availability, transmission rate, or packet error rate.

In Example 111, the non-transitory computer readable medium of Example 110, wherein the processor determining the expected throughput includes the processor determining the expected throughput as a product of channel availability, transmission rate, and packet error rate.

In Example 112, the non-transitory computer readable medium of any one of Examples 107 to 111, wherein operating according to the first operational mode includes performing a new transmit power search.

In Example 113, the non-transitory computer readable medium of any one of Examples 107 to 112, wherein operating according to the first operational mode includes selecting a new candidate power backoff.

In Example 114, the non-transitory computer readable medium of any one of Examples 107 to 113, wherein operating according to the second operational mode includes transmitting a data packet according to the candidate power backoff.

In Example 115, the non-transitory computer readable medium of any one of Examples 107 to 114, wherein the error rate is a packet error rate.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all claims included herein.

What is claimed is:

1. A computing device comprising:
an interface to a first antenna and a second antenna; and
a processor, configured to perform an antenna hopping operation, wherein the antenna hopping operation comprises:
calculating a first transmit power value representing a transmit power on the first antenna during a transmit period; and
when the first transmit power value reaches a threshold, controlling a baseband modem to begin a second transmit period on the second antenna.

2. The computing device of claim 1, wherein the antenna hopping operation further comprises, when the first transmit power value reaches the threshold, controlling the baseband modem to discontinue transmission on the first antenna during the second transmit period.

3. The computing device of claim 1, wherein the antenna hopping operation further comprises the processor calculating a second transmit power value representing a transmit power on the second antenna during the second transmit period; and when the second average transmit power reaches a threshold, beginning a third transmit period on the first antenna or a third antenna.

4. The computing device of claim 3, wherein the antenna hopping operation further comprises, when the second transmit power value reaches the threshold, controlling the baseband modem to discontinue transmission on the second antenna during the third transmit period.

5. The computing device of claim 1, wherein the first transmit power value is a mean of transmit power on the first antenna relative to time during the first transmit period; and wherein the second transmit power value is a mean of transmit power on the second antenna relative to time during the second transmit period.

6. The computing device of claim 1, further comprising a plurality of second antennas, wherein the second antenna is a second antenna of the plurality of second antennas; wherein the processor is further configured to successively begin a transmit period on each antenna of the plurality of second antennas; calculate a transmit power value on the each antenna of the plurality of second antennas; and when the transmit power value on the each antenna of the plurality of second antennas reaches the threshold, to discontinue transmission on the each antenna of the plurality of second antennas and to begin a transit period on another antenna.

7. The computing device of claim 1, further comprising a proximity sensor, configured to detect a proximity of the first antenna and to generate proximity sensor data representing the detected proximity of the first antenna; wherein if the proximity sensor data is outside of a range, the processor is configured to operate according to a first operational mode; wherein the processor is configured to, if the proximity sensor data is within the range, operate according to a second operational mode; wherein operating according to the first operational mode comprises performing the antenna hopping operation; and wherein operating according to the second operational mode comprises discontinuing the antenna hopping operation.

8. A computing device comprising:
a sensor, configured to detect a human body part within a proximity of an antenna and to generate sensor data representing the detected proximity;
a processor, configured to:
if the sensor data are outside of a range, operate according to a first operational mode; and
if the sensor data are within the range, operate according to a second operational mode;
wherein operating according to the first operational mode comprises the processor classifying data to be transmitted on the antenna as data of a first type or a second type; transmitting the data of the first type a first power level and transmitting the data of the second type at a second power level, different from the first power level.

9. The computing device of claim 8, wherein the first type are critical data, and the second type are non-critical data, and wherein the first power level is a maximum power level minus a first value, and the second power level is the maximum power level minus a second value;
and wherein the first value is less than the second value.

10. The computing device of claim 8, wherein the sensor is configured to determine whether the computing device is connected to a dock, or whether a lid of the computing device is closed.

11. The computing device of claim 8, wherein the first type are critical data, and the second type are non-critical data; wherein the data comprise Physical Uplink Control Channel (PUCCH) data, and wherein the processor classifying data as data of the first type or the second type comprises the processor classifying PUCCH type 1, 1a, and 1b data as data of the first type, and PUCCH type 2, 2a, and 2b data as data of the second type.

12. The computing device of claim 8, wherein the first type are critical data, and the second type are non-critical data; wherein the data comprise Physical Uplink Shared Channel (PUSCH) data comprising Radio Resource Control (RRC) signaling messages, application data, user data, or uplink control information; and wherein the processor classifying data to be transmitted on the antenna as data of a first type or a second type comprises the processor classifying the RRC signaling messages and uplink control information as data of the first type and classifying application data and/or user data as data of the second type.

13. The computing device of claim 8, wherein the first power level is a power level between the maximum power level and zero power, and greater than the second power level.

14. The computing device of claim 8, wherein the second power level is zero power.

15. The computing device of claim 14, wherein transmitting the data of the second type at zero power comprises skipping the scheduled transmission to reduce a time average transmit power level.

16. A computing device, comprising:
a baseband modem, configured to instruct to simultaneously or concurrently transmit on a first antenna and a second antenna; and
a processor, configured to:
determine a transmission power difference, wherein the transmission power difference is a difference between a first transmission power of a transmission on the first antenna and a second transmission power of a transmission on the second antenna;
if the transmission power difference is outside of a range, determine a new transmission rate for a transmission on the first antenna or the second antenna.

17. The computing device of claim 16, wherein if the transmission power difference is within the range, the processor is configured to control the baseband modem to transmit at a previous transmission rate.

18. The computing device of claim 16, wherein if either the cumulative transmit power difference is within the first range, or if the first cumulative transmit power is within the second range, and a difference between a maximum transmit power of the first antenna and a maximum transmit power of the second antenna is outside of a third range, the processor is further configured to determine a new transmission rate for a transmission on the first antenna or the second antenna.

19. The computing device of claim 18, wherein if either the cumulative transmit power difference is within the first range, or if the first cumulative transmit power is within the second range, and a difference between a maximum transmit power of the first antenna and a maximum transmit power of the second antenna is outside of a third range, the processor is further configured to control the baseband modem to transmit on an antenna of the first antenna or the second antenna having a greatest maximum transmit power.

20. The computing device of claim 16, wherein the processor is further configured to determine a cumulative transmit power difference, wherein the cumulative transmit power difference is a difference between a first cumulative transmit power on a first antenna over a duration and a second cumulative transmit power of a second antenna over the duration; wherein if the cumulative transmit power difference is outside of a first range, and if first cumulative transmit power is outside of a second range, the processor is configured to control the baseband modem to transmit on the second antenna; wherein if the cumulative transmit power difference is outside of the first range, and if first cumulative transmit power is outside of the second range, the processor is further configured to control the baseband modem to discontinue transmission on the first antenna.

21. The computing device of claim 16, wherein the processor is configured to receive first proximity sensor data from a first proximity sensor, configured to detect a proximity of a human body part in a vicinity of the first antenna; wherein the processor is configured to receive second proximity sensor data from a second proximity sensor, configured to detect a proximity of a human body part in a vicinity of the second antenna; and wherein the processor is configured to determine the maximum transmit power of the first antenna and the maximum transmit power of the second transmit antenna based on the first proximity sensor data and the second proximity sensor data.

22. A computing device, comprising:
a processor, configured to:
determine a required throughput for data to be wirelessly sent by the computing device;
select a candidate power backoff for transmission of the data;
determine a throughput at the candidate power backoff;
if the expected throughout is less than the required throughout, operate according to a first operational mode; and
if the expected throughout is greater than the required throughout, operate according to a second operational mode.

23. The computing device of claim 22, wherein the processor is configured to determine the required throughput based on one or more data traffic categories.

24. The computing device of claim 22, wherein the processor determining the required throughput based on the one or more data traffic categories comprises the processor determining a required throughput for a plurality of data traffic categories and summing the required throughput for the plurality of data traffic categories.

25. The computing device of claim 22, wherein the processor determining the expected throughput comprises the processor determining the expected throughput based on any of channel availability, transmission rate, or packet error rate.
